(19) United States
(12) Patent Application Publication
(10) Pub. No.: US 2013/0024393 A1
(43) Pub. Date: Jan. 24, 2013

(54) Cloaked Package Shipping Methods and Systems for Performing the same

(71) Applicant: Abbott Fleur, Bedford, NY (US)

(72) Inventor: Abbott Fleur, Bedford, NY (US)

(21) Appl. No.: 13/549,537

(22) Filed: Jul. 16, 2012

Related U.S. Application Data
(60) Provisional application No. 61/509,166, filed on Jul. 19, 2011.

(51) Int. Cl. G06Q 50/28

(52) U.S. Cl. 705/333; 705/330

(57) ABSTRACT

Systems and methods for the transportation, delivery or shipment of packages by common or private carrier between a first party shipping a package and a second party receiving the package wherein other parties can not associate the identities or addresses of both parties related to the shipment.

### FIELD OF THE INVENTION

The present invention pertains to a systems and methods for the transportation, delivery or shipment of packages by common or private carrier between a first party shipping a package and a second party receiving the package wherein other parties can not associate the identities or addresses of the parties related to the shipment.

### BACKGROUND OF THE INVENTION

There are a variety of commercial methods for shipping and tracking packages between parties. Typically, the shipper's address is on the shipping label to show origin and provide a return address and the receiver's address is on the shipping label for the package to ensure the package arrives at the right destination. However, in certain consumer transactions, consumers are able to order and receive purchased items without disclosing their identity for privacy reasons. U.S. Pat. No. 7,213,748 to Tsuei et al.; U.S. Pat. No. 7,848,961 to Estes, et al.; U.S. Pat. No. 6,931,388 to Robbins; U.S. Pat. No. 7,454,356 to Fields, et al.; U.S. Pat. No. 7,693,798 to Anderson et al.; U.S. Pat. No. 6,748,366 to Hurwitz et al.; U.S. Patent Publication 20030204445 to Vishik et al.; U.S. Patent Publication 20110040650 to Johnson; U.S. Patent Publication 20020013739 to O'Donnell, et al.; and U.S. Patent Publication 20080004972 to Ghanma, each hereby incorporated by reference, describe methods and systems relating to the delivering of packages.

### SUMMARY OF THE INVENTION

The present invention allows a shipper to ship documents or packages to a consignee or receiver by hiding or concealing the shipper and/or consignee information (e.g. individual, company or entity name, specific address or other identifying information) at appropriate times during the progress of the shipment. This approach allows these “cloaked” shipments to be handled via existing carrier system and still prevent unrelated parties or parties other than the original shipper and consignee from associating the shipment (or the shipper) with the consignee and/or the shipment with shipper.

For example, when documents or packages of a sensitive or confidential nature are sent from one party (shipper) to another (consignee) these (related) parties to the shipment may not want anyone else (e.g., carrier employees, mailroom employees, etc.) to be able to associate the two parties with each other. Under certain constraints, third parties learning or knowing both the shipper and the consignee can be as damaging to the related parties as seeing the contents of the shipment. For example, if Company A is planning to merge with or acquire Company B, an increase in the volume of packages or shipments between the companies (sometimes competitors) may tip off employees of commercial carriers or even either company's mailroom staff of the potential transaction. As another example, a company's plans to hire a CEO or other senior executive from another company might result in mailings back and forth and risk tipping off employees of either company, including possibly the employee being replaced. As another example, a company may confidentially seek to evaluate a new supplier without any word getting out to customers, competitors or the company's existing supplier. Any leaks relating to potential mergers, acquisitions, hiring, recruitment, purchase, sales or similar transactions can sometimes prevent the transactions from ever closing or continuing forward.

According to one aspect of the invention, identifying information relating to the shipper and identifying information relating to the consignee are concealed, hidden, disguised or otherwise withheld from disclosure to others during part or all of the delivery. This allows a shipper to send a package to a consignee without anyone other than the shipper and consignee knowing the shipment transaction between the two took place.

According to one embodiment, at one end of the delivery, an executive uses a computer to access a delivery company's website and inputs the shipper and consignee information and makes a request for a “cloaked” shipment thereby generating routing information (for example on a label to affix to the package) without the consignee information and, preferably without the shipper information.

According to one embodiment, the initiator of the process is the shipper. In preparing a shipment, the shipper may indicate to the carrier system (e.g., FedEx, DHL, UPS or other common carrier) that the shipment be delivered with both the shipper's address and the consignee's address hidden, concealed, disguised or otherwise withheld (“cloaked”) during part or all of the shipment. The shipment data that is stored on the carrier's server(s) or other computer-based system may have an original waybill identifier and may contain the complete shipper and consignee information. The physical “shipper waybill” that the shipper attaches to the shipment may contain the complete shipper information and may contain cloaked (fictitious) consignee information. In addition, the shipper waybill may contain a unique shipper waybill identifier that prevents an unrelated party from accessing actual shipment status and may also allow the carrier to route the cloaked package through a special “cloaking station” or “cloaking procedure” within the carrier's logistics operation (vehicle, warehouse, and the like).

Preferably, hen the cloaked package is at a cloaking station, the carrier may replace the shipper waybill on the package with a “consignee waybill”, which may contain the complete consignee information and may contain cloaked (fictitious) shipper information. In addition, the consignee waybill may contain cloaked (fictitious) shipper information. In addition, the consignee waybill may contain a unique consignee waybill identifier that prevents an unrelated party from accessing actual shipment status and may also allow the carrier to confirm the the shipment has been properly cloaked. That is, the shipment enters the shipment process with only the shipper's address displayed, but exits the system with only the consignee's address.

Queries into the shipper's server for tracking information may show different status information based upon which waybill identifier is used, original, shipper or consignee.

In addition, the carrier may allow the shipper and consignee to create a unique relationship identifier that allows the two parties to view the status of all shipments between them. The relationship may be controlled by unique passwords.

According to another embodiment, once the shipper requests that a shipment be cloaked, a shipment or tracking number is associated with the package (e.g., on the shipping label, used to access the electronic record, etc.), however, the shipper and/or consignee information is concealed, hidden, disguised or otherwise not displayed. For example, anyone looking at the shipping package would not know the true origin and/or destination. Preferably, accessing the electronic record using the number merely provides information regarding the next shipping location rather than the final consignee location. Preferably, the shipping label includes the shipping number and either fake shipper and/or consignee names and addresses or no address information is displayed on the label.

### BRIEF DESCRIPTION OF THE DRAWINGS

FIG. 1 is a block diagram of an exemplary server based system for carrying out an embodiment of the present invention.

FIG. 2 is an exemplary process flow on the server of a cloaked shipment according to an embodiment of the present invention.

FIG. 3 is an exemplary process flow on the server for the creation of a cloaked shipping waybill by a shipper according to an embodiment of the present invention.

FIG. 4 is an exemplary process flow on the server for the en route changing of a cloaked waybill for the shipper to a cloaked waybill for the consignee by a carrier according to an embodiment of the present invention.

FIG. 4a is an exemplary process flow on the server for the en route changing of a cloaked waybill for the shipper to a cloaked waybill for the consignee by a carrier using unique shipper and consignee waybill identifiers according to an embodiment of the present invention.

FIG. 5 is an exemplary process flow on the server for the requesting of shipment tracking status by a shipper, consignee or other third party according to an embodiment of the present invention.

FIG. 5a is an exemplary process flow on the server for the requesting of a shipping list and selection of a specific shipment by a shipper, consignee or other third party according to an embodiment of the present invention.

FIG. 5b is an exemplary process flow on the server for the validation of a user id and password, if required, by a shipper, consignee or other third party according to an embodiment of the present invention.

FIG. 6 is an exemplary process flow on the server for generating the cloaked shipper and consignee information to be used on the cloaked waybills.

FIG. 7 is an exemplary process flow of a cloaking station where shipper and consignee cloaked waybills are swapped and verified.

FIG. 8 is a block diagram that depicts a system architecture in accordance with an embodiment of the present invention.

FIG. 9 is a block diagram that depicts a computing device in accordance with an embodiment of the present invention.

### DETAILED DESCRIPTION OF THE PREFERRED EMBODIMENTS OF THE INVENTION

The following terms, as defined here, are used throughout the description of the present invention and the claims.

As used herein, a “shipper” refers to a person or department or company or entity that is shipping a package.

As used herein, a “consignee” refers to a person or department or company or entity that will be receiving a package. Also, referred to as the receiver, recipient or final shipping designation.

As used herein, a “carrier” refers to a company that transports a package between a shipper and consignee. In addition, the carrier may be responsible for maintaining the security and integrity of the package while it is in-transit.

As used herein, a “package” refers to the item that is being shipped by the carrier, from the “shipper” to the “consignee”.

As used herein, a “logistics system” refers to any and all parts of a carrier's infrastructure that moves a package between a shipper and consignee. These include, but are not limited to warehouses, trucks, boats, airplanes and personnel used by the carrier.

As used herein, “routing information” may include the physical addresses of both the “shipper” and the “consignee” and intermediate shipping locations.

As used herein, a “waybill” refers to the shipping directions that appear on or are affixed to the “package” that contains the “routing information”. The label can be printed on or affixed to a package or is can be an electronically readable image or device.

As used herein, “cloaking” is the process of obscuring part or all of the routing information from visual or electronic scanning, sensing or detecting and includes hiding, concealing, withholding and disguising (e.g., using fake or names/addresses other than shipper and/or consignee).

As used herein, a “cloaking station” is any “carrier” location where “waybill” routing information is modified. At this station, in a preferred embodiment of the invention, the “shipper” information is “cloaked” and the “consignee” information is un-cloaked.

It is preferred that the present invention not be limited by the specific disclosure herein. In referring to the waybill identifier, this includes, but is not limited to, printed information, scanable or encoded printed information and electronic and scanable devices (e.g. electronic id or RFID tags). In addition to the customary carrier waybill identifier, unique shipper waybill and consignee waybill numbers can be created. This means that only the shipper has knowledge of the original waybill number and the associated tracking information.

In accordance with the present invention, a shipper wants to send a package to a consignee via a carrier. Once the shipper creates the shipment (attaches the waybill), no other third party should able to associate both the shipper and the consignee with the package at the same time. This can include employees at both the shipper and consignee, other than the original sender and final recipient.

One aspect of the invention relates to a method for delivering a package from a shipper to a consignee comprising:
(a) obscuring the consignee's identification during a first portion of said delivery between said shipper and said consignee; and
(b) obscuring the shipper's identification during a second portion of said delivery between said shipper and said consignee.

Preferably, said shipper identification includes shipper name and address and consignee identification includes consignee name and address.

Preferably, said first portion of said delivery starts after said package leaves said shipper and ends at a first midpoint between said shipper and said consignee.

Preferably, said second portion of said delivery starts at a second midpoint between said shipper and said consignee and ends before said package is delivered to said consignee.

Preferably, said second midpoint is after said first midpoint.

Preferably, said first midpoint and said second midpoint are the same.

Preferably, said shipper's identification and said consignee's identification are both obscured during said first portion and said second portion.

Preferably, said consignee's identification is disguised during said first portion.

Preferably, said shipper's identification is disguised during said second portion. According to one preferred embodiment, said consignee's identification is disguised during said first portion and said shipper's identification is disguised during said second portion.

Preferably, further comprising generating a first waybill for package application for said first portion that obscures said consignee's identification.

Preferably, further comprising generating a second waybill for said second portion that obscures said shipper's identification.

Preferably, further comprising generating a first waybill for said first portion that disguises said consignee's identification.

Preferably, further comprising generating a second waybill for said second portion that disguises said shipper's identification.

Preferably, further comprising generating a first waybill for said first portion that omits said consignee's identification.

Preferably, further comprising generating a second waybill for said second portion that omits said shipper's identification.

Preferably, further comprising generating a waybill that obscures said shipper's identification and said consignee's identification.

Preferably, further comprising generating a waybill that disguises said shipper's identification and said consignee's identification.

Preferably, further comprising generating a waybill that omits said shipper's identification and said consignee's identification.

Preferably, further comprising receiving a request from said shipper to cloak said shipper identification and/or said consignee identification.

Preferably, further comprising receiving a request from said shipper to obscure said shipper identification and/or said consignee identification.

Preferably, further comprising receiving a request from said shipper to omit said shipper identification and/or said consignee identification.

Preferably, further comprising receiving a request from said shipper to disguise said shipper identification and/or said consignee identification.

Preferably, further comprising generating fictitious shipper and consignee routing information to disguise the shipper and consignee information

Preferably, further comprising creating shipping documents that disguise the shipper and the consignee.

Preferably, further comprising creating shipping documents that omit the shipper identification and the consignee identification.

Preferably, further comprising creating shipping documents that includes fictitious routing information.

Preferably, further comprising replacing consignee disguised routing information with shipper disguised routing information.

Preferably, further comprising allowing said shipper to track said package during delivery.

Preferably, further comprising allowing said consignee to track said package during delivery.

Preferably, further comprising notifying said consignee of said shipment.

Preferably, further comprising notifying said consignee of said shipment and it's cloaked status.

Preferably, further comprising assigning a cloaked shipment identification to the package in addition to a carrier assigned shipment identification.

Preferably, comprising automatically creating fictitious shipper and consignee routing information. According to a preferred embodiment, the method further comprises storing fictitious shipper/consignee routing information. Preferably, the method further comprises selecting existing fictitious shipper and consignee routing information from one or more computer-based databases. Preferably, the method further comprises assigning cloaked consignee identification to the package and the actual shipper information for outbound transit from the shipper.

Preferably, further comprising using cloaked shipper information and the actual consignee information for inbound transit to the consignee.

Preferably, further comprising using fictitious shipper information, a shipment identification, a carrier assigned identification and the actual consignee information for inbound transit to the consignee.

Preferably, comprising producing limited shipping status information about the in-transit package when tracked via an in-transit shipment id. According to a preferred embodiment the method further comprises using a unique shipper waybill identifier. Preferably, further comprising using a unique consignee waybill number.

Preferably, further comprising allowing said shipper and said consignee to share all cloaked package shipment information via a user identifier and password.

Another aspect of the invention relates to a method for delivering a package from a shipper to a consignee using a computer-based system, comprising:
receiving by a server a request from said shipper to deliver said package using cloaked shipment to said consignee;
determining whether one or more rules associated with cloaked shipment apply to the request from said shipper;
processing the request if all rules determined to be applicable are satisfied; and
denying the request if one or more rules determined to be applicable are not satisfied;
wherein method delivers said package from said shipper to said consignee and further comprises:
   (i) obscuring the consignee's identification during a first portion of said delivery between said shipper and said consignee; and
   (ii) obscuring the shipper's identification during a second portion of said delivery between said shipper and said consignee.

Yet another aspect relates to computer based system capable of facilitating the delivery of packages from one or more shippers to one or more consignees comprising a processor coupled to a memory, the memory having computer readable code, which when executed by the processor causes the computer system to perform the methods described above.

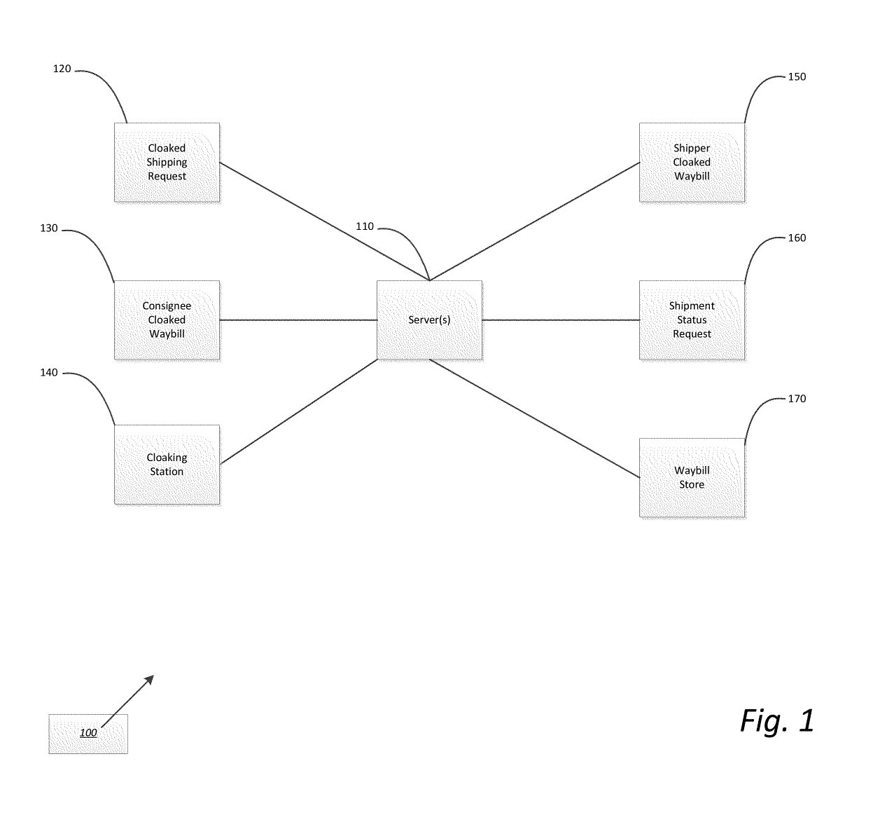

FIG. 1 is a block diagram of a server system 100 for carrying out this present invention. The carrier server 110 is a conventional computer system (e.g., an HP Edge server). Alternatively, it may be implemented as a server farm, co-located or distributed over a network. The server receives a cloaked shipping request from a shipper 120 to create a cloaked shipment. The server creates a consignee cloaked waybill 130 (the consignee name and location are obfuscated) which the shipper attaches to the package being cloaked. The server receives notification from a cloaking station 140 that a cloaked package needs handling. The server creates a shipper cloaked waybill (the shipper name and location are obfuscated while the consignee information is in the clear) 150 which is used to replace the consignee cloaked waybill on the package. The server handles shipment status requests 160, returning tracking information limited by the “need to know” status of the requestor. The server stores and maintains complete waybill information in the waybill store 170.

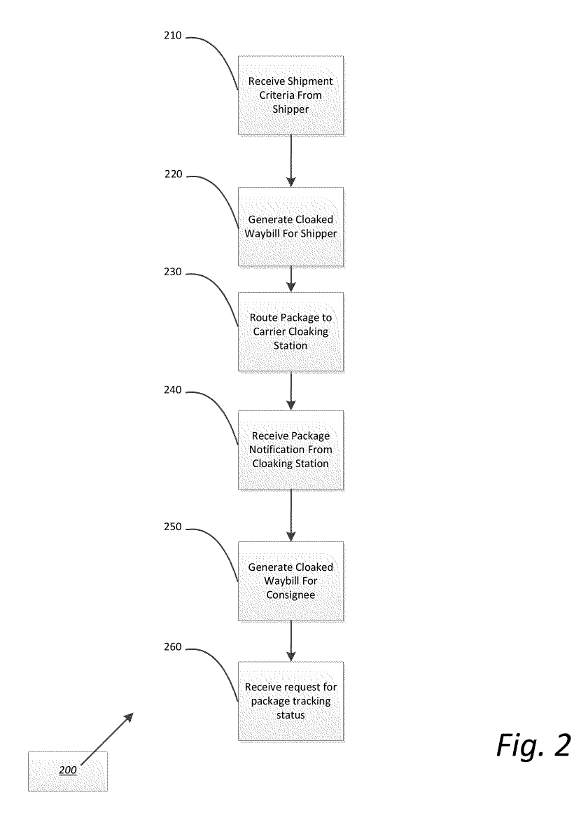

An embodiment of the server system 200 is shown in FIG. 2 in which a server receives a shipment request from a shipper 210. The request may include customary shipper, consignee, packaging and routing. In addition, the request may contain an indication that the shipment is to be cloaked. The server creates a cloaked waybill for the shipper 220. The waybill may have both the consignee information and the waybill identifier obfuscated so that an outside observer can not determine the identity of the consignee or retrieve valid tracking (package status) information from the server. The shipper may affix this waybill to the cloaked package being shipped and put the package into the carrier's logistics system. The server sets the package routing so that it travel to (through) a carrier cloaking station 230 The server receives a package notification from a cloaking station 240 that the cloaked package may require a waybill change at which point. The server may generate a cloaked waybill for the consignee 250. The server may receive a request for tracking the cloaked package's status 260.

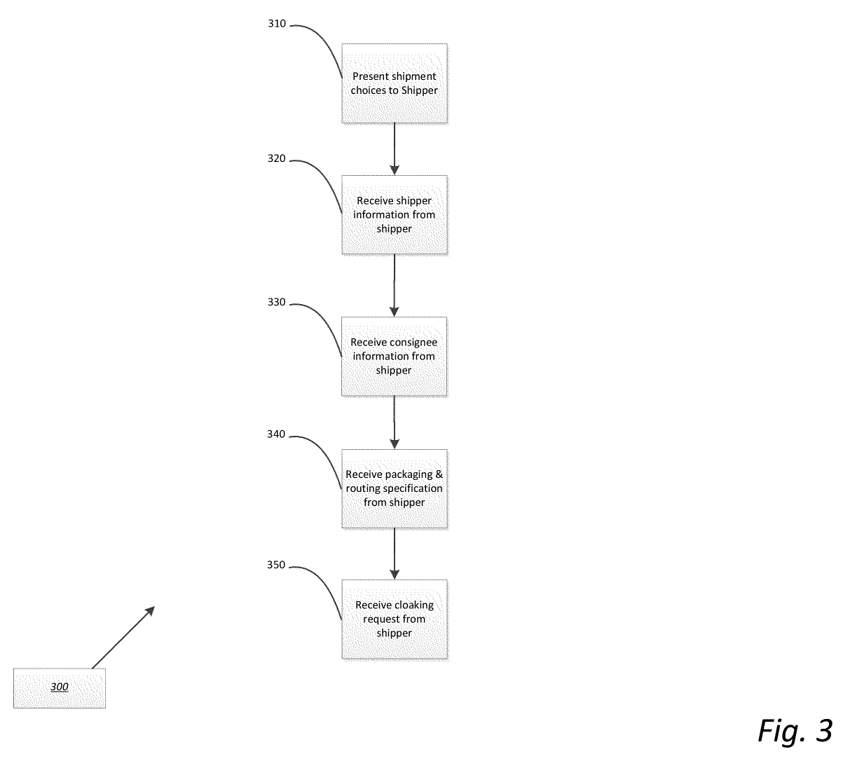

Server 110 receives shipping criteria from shipper at step 210 in 300 as detailed in FIG. 3. The server presents to the purchaser various shipment specification choices at step 310. The request may include customary shipper, consignee, packaging and routing information. In an automated environment, this step may be skipped, since the shipper system will already be set up for this request. The server receives shipper information from the shipper 320. This may include contact information and address as well as cloaked information, as per shipper. The server receives consignee information from the shipper 330. This may include contact information and address as well as cloaked information, as per shipper. The server receives packaging and routing specifications from the shipper 340. This may include type of package, size and preferred shipment method. The server receives a cloaking request from the shipper 350. This may indicate to the server that waybill information and tracking requests will be handled in a way that supports cloaking.

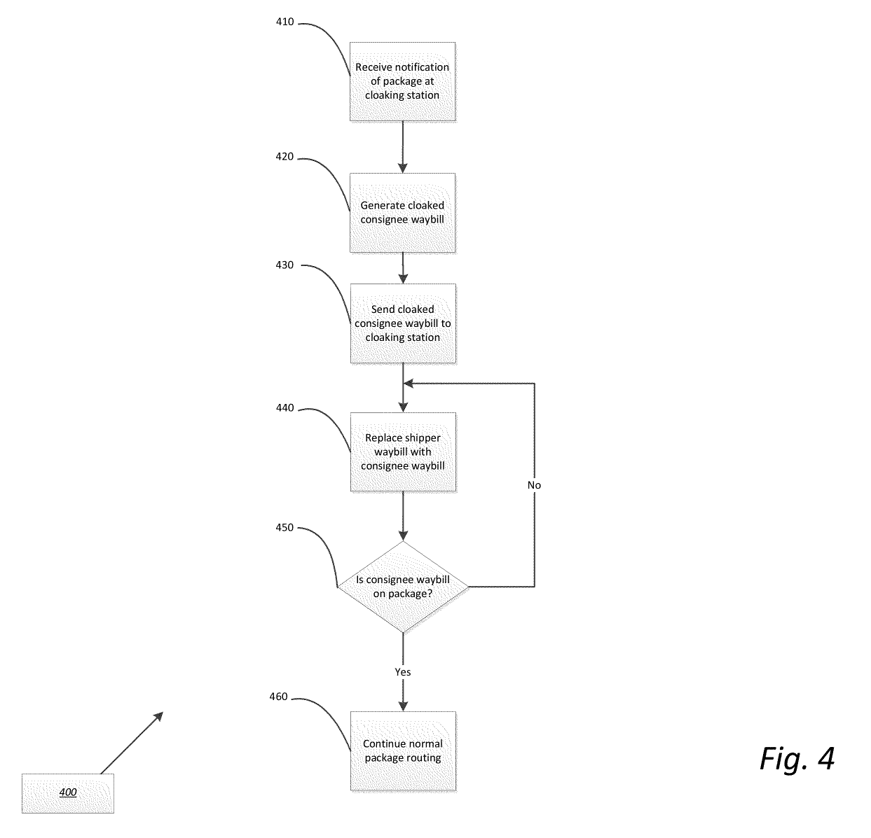

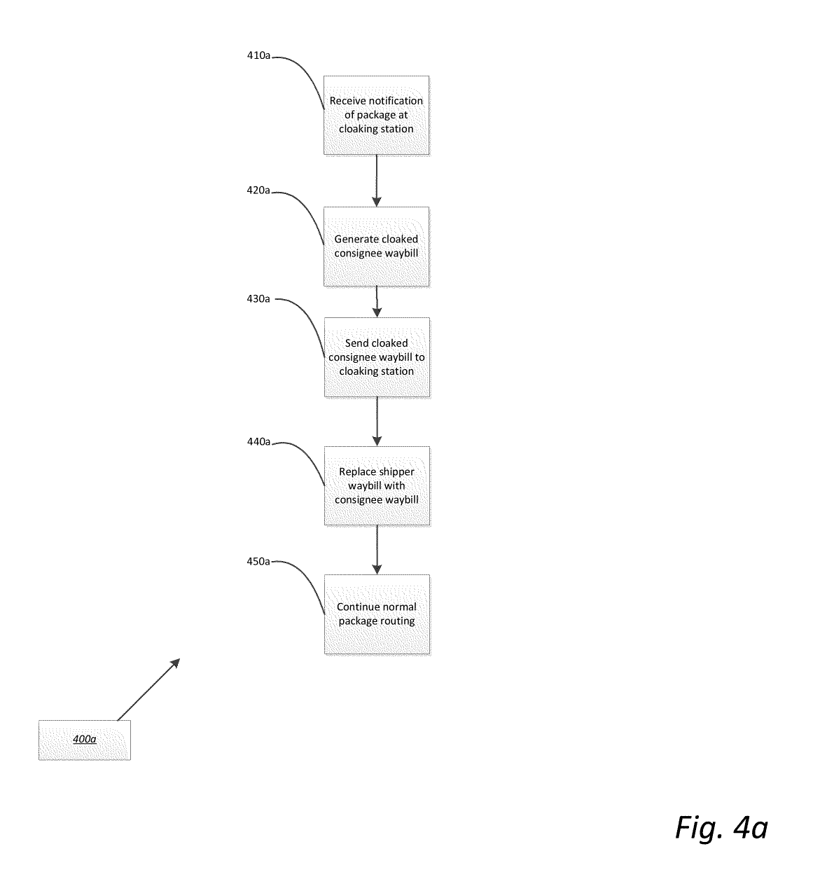

In one embodiment of step 230, server 110 receives a package notification from a cloaking station in 400 as detailed in FIG. 4. The server receives a notification that a cloaked waybill for shipper is at a cloaking station at step 410. The server generates a cloaked consignee waybill at step 420. The contents of the cloaked shipper information may be determined by shipper cloaking criteria. The server sends the cloaked consignee waybill to the cloaking station 430. The waybill may have both the shipper information and the waybill identifier obfuscated so that an outside observer can not determine the identity of the shipper or retrieve valid tracking (package status) information from the server. The cloaking station operator may remove or obscure the cloaked shipper waybill and affix the cloaked consignee waybill to the package being shipped at step 440. The package is scanned to verify that the consignee waybill is now attached to the package at step 450. If the consignee waybill is not attached, the operator is notified to go back to step 440 and replace the shipper waybill with the consignee waybill. Once the new cloaked consignee waybill is affixed to the package, the package continues being routed through the carrier's logistics system and delivered to the consignee at step 460.

Another embodiment of step 230, server 110 receives a package notification from a cloaking station at step 230 in 400a as detailed in FIG. 4a. The server receives a notification that a cloaked waybill for shipper is at a cloaking station at step 410a. The server generates a cloaked consignee waybill at step 420a. The contents of the cloaked shipper information may be determined by shipper cloaking criteria. The server sends the cloaked consignee waybill to the cloaking station 430a. The waybill may have both the shipper information and the waybill identifier obfuscated so that an outside observer can not determine the identity of the shipper or retrieve valid tracking (package status) information from the server. The cloaking station operator may remove or obscure the cloaked shipper waybill and affix the cloaked consignee waybill to the package being shipped at step 440a. The package continues being routed through the carrier's logistics system and delivered to the consignee at step 450a.

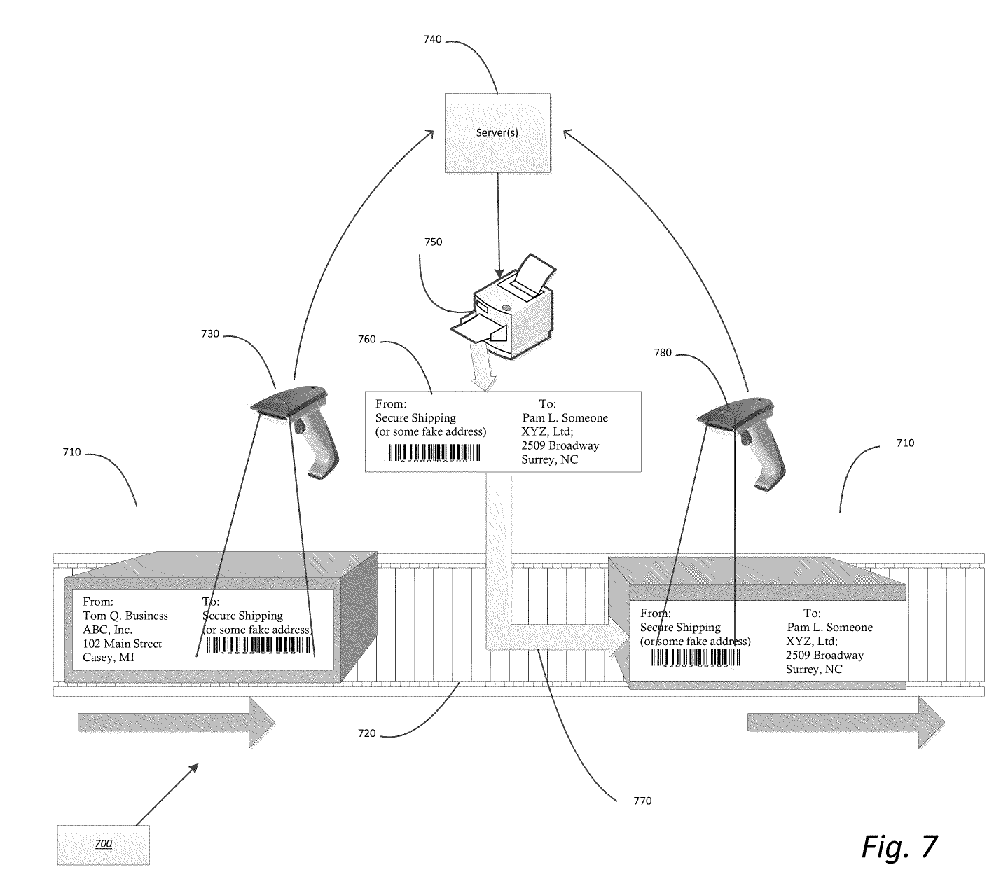

A physical embodiment of the cloaking station of step 230 in 700 as detailed in FIG. 7 shows a package with a cloaked shipper waybill 710 traveling on conveyor 720 has its shipper waybill identifier scanner by a scanner 730. Although this embodiment shows a barcode scanner, the scanner can be any type of scanner that can sense printed, radio wave or other types of unique package identifiers. The server 740 receives a notification that a cloaked shipper waybill is at the cloaking station. The servicer sends the replacement consignee waybill to the cloaking station printer 750. Although this embodiment shows a traditional printer, the waybill can be created using any technology that allows the package to be scanned and identified. The new consignee waybill 760 replaces 770 the original shipper waybill on the package. A validation scanner 780 scans the package and the server receives the scanned package identifier to confirm that the consignee waybill has been affixed to the package. The package continues through normal carrier routing.

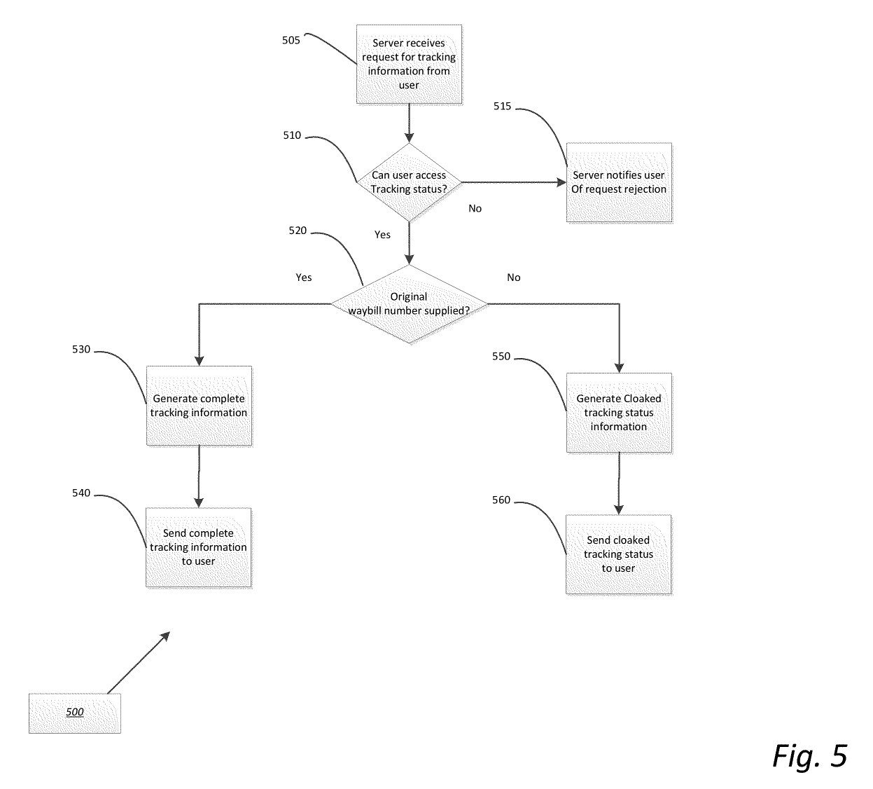

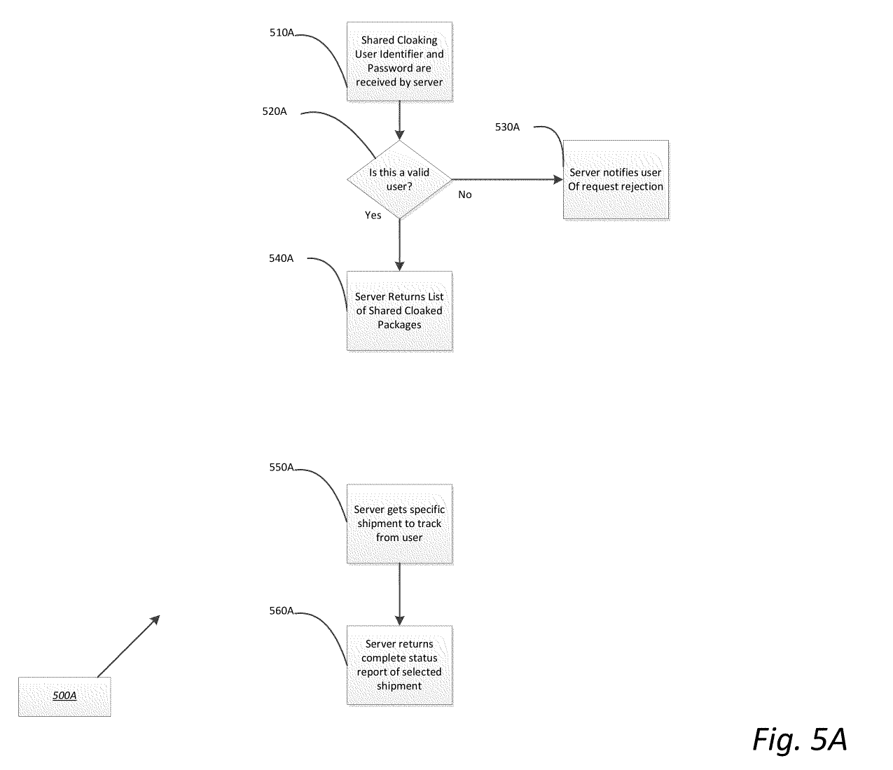

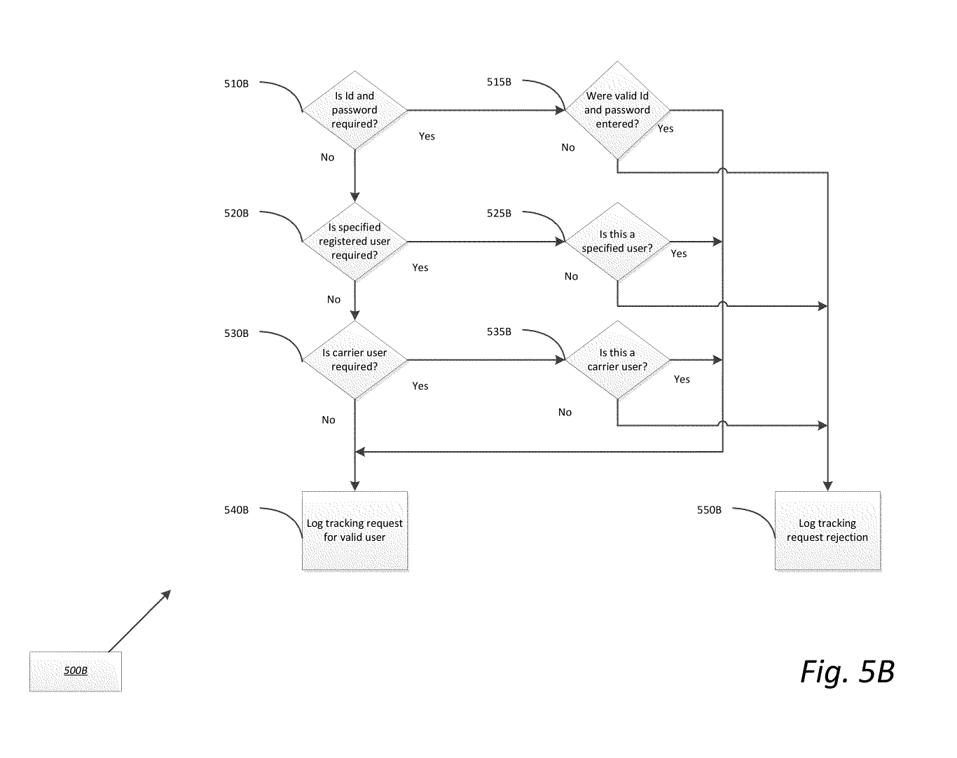

Server 110 receives a request for tracking package status at step 505 in 500 as detailed in FIG. 5. If a user id and password are required to access this package at step 510 (as detailed in FIG. 5B) and are valid, the user can access tracking status. If invalid, the server notifies the user at step 515 of the request rejection. If the original waybill number is supplied 520, the server generates the complete tracking information for the package 530 and sends this information to the requestor 540. If the cloaked waybill number is supplied, then the server generates a limited amount of tracking information (as set by carrier) 550 and sends this information to the requestor 560.

Server 110 receives a user identifier and password from user as a request to view all shipments between shipper and consignee at step 510A in 500A as detailed in FIG. 5A. If the user id and password are valid at step 520A (as detailed in FIG. 5B) and are valid, the user can access tracking status. If invalid, the server notifies the user at step 530A of the request rejection. The server creates and returns a list of all shared shipments between the shipper and consignee 540A. The list contains an indication of the current status of each shipment. The server then gets a tracking request for a specific shipment in the list 550A. The server creates a status display of the specified shipment and returns it to the user 560A.

Server 110 receives a request to validate user checking to see if id and password are required at step 510B in 500B as detailed in FIG. 5B. If they are required, the id and password are validated 515B. If invalid, the request is rejected and logged 550B. If valid, the request is approved and logged 540B. If the user must be a specific registered user 520B, the user specification is checked 525B. If invalid, the request is rejected and logged 550B. If valid, the request is approved and logged 540B. If the user must be any carrier user 530B, the user status is checked 535B. If invalid, the request is rejected and logged 550B. If valid, the request is approved and logged 540B.

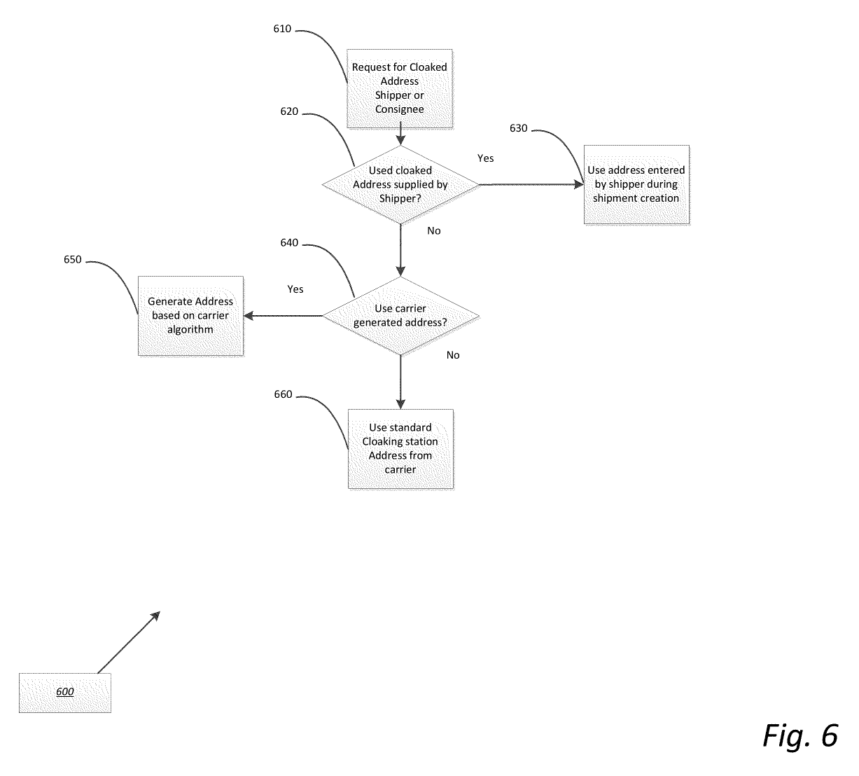

Server 110 receives a request for a cloaked shipper or consignee address in steps 220 and 250 in 600 as detailed in FIG. 6. If the shipper supplied a cloaked address 620, use the address entered by the shipper during shipment creation 630. If the shipper requested to use an address generated by the carrier 640, a carrier generated address is created 650. If not specified 660, the standard carrier cloaking station address is created.

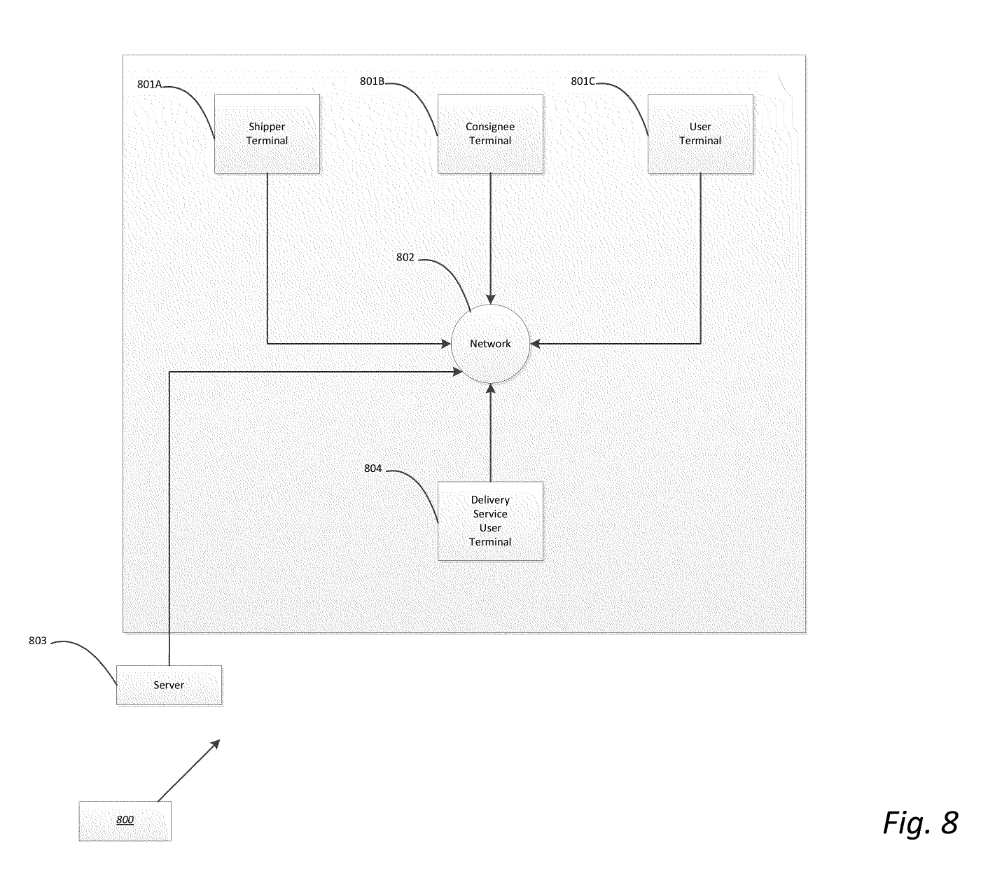

FIG. 8 illustrates a system 800 according to another embodiment of the invention. System 800 includes shipper terminal 801A, consignee terminal 801B, and delivery service user terminal 804 in which the delivery or shipment methods according to the invention may be executed. Shipper terminal 801A and consignee terminal 801B may be computers, laptops, tablets, smart phones or other computer based systems or devices used by executives or employees of companies or other entities. System 800 may also include user terminal 801C which may be a computer-based terminal used by a company's mailroom or employees, a contractor service (e.g., Pitney Bowes, etc.), an intermediate delivery service provider (e.g., a Fed Ex contractor), a government employee (e.g., inspector), or a user not related to the shipper-consignee delivery also accessing server 803 via network 802 regarding a separate shipment, etc. According to preferred embodiments of the invention, individuals using user terminal 801C would not have access to cloaked information relating to the shipper and/or consignee (e.g., the shipper's identification and address, the consignee's identification and address, or both are either concealed, suppressed or disguised preferably by server 803). According to one preferred embodiment, a shipper inputs a shipment request and information with a further request to “cloak” the shipment using shipper terminal 801A which is connected to server 803 via network 802, preferably through two-way communication links. Preferably, the shipper input the shipment request without a previous request by consignee for the shipment. For example, the shipment request is made without a corresponding customer order by consignee. Network 802 may be any suitable telecommunications network, preferably a public wired, optical or wireless switched network, such as the Internet, an Intranet, LAN, or the like. Network 802 may include a standard telecommunications network such as is operated by AT&T or Verizon. At various locations, preferably geographically remote from that of server 803, a number of intermediate local servers may connect server 803 via network 802 to terminals 801A, 801B and 801C. A shipper preferably accesses server 803 via network 802 using shipper terminal 801A, while a consignee using consignee terminal 801B. System 800 may further comprise delivery service terminal 804 which is also connected to server 803 via network 802. Delivery service user terminal 804 may include one or more computer-based terminals of delivery service providers (e.g., used by employees or contractors, US Post Office, United Parcel Service, UPS, Federal Express, DHL, etc.). According to preferred embodiments of the invention, individuals using delivery service user terminal 804 would also not have access to cloaked information (e.g., the shipper's identification and address, the consignee's identification and address, or both are either concealed, suppressed or disguised preferably by server 803).

According to further preferred embodiments, system 800 includes at least one delivery service user terminal 804 in a first portion of the shipment from shipper to consignee and at least one delivery service user terminal 804 in a second portion of the shipment from shipper to consignee. Preferably, consignee information is cloaked or concealed to the delivery services user terminals 804 in the first portion, while shipper information is cloaked or concealed to the delivery services user terminals 804 in the second portion. Preferably, a single tracking number or identification is associated with the package being shipped and is used by delivery services user terminals 804 to route the package without knowing the shipper and/or consignee information (e.g., the shipper's identification and address, the consignee's identification and address, or both are either concealed, suppressed or disguised). According to another preferred embodiment, each delivery service location or delivery service user terminal 804 only accesses information relating to the next step in the shipment process (e.g., the next location the package is being forwarded to) without knowing the final destination of the consignee.

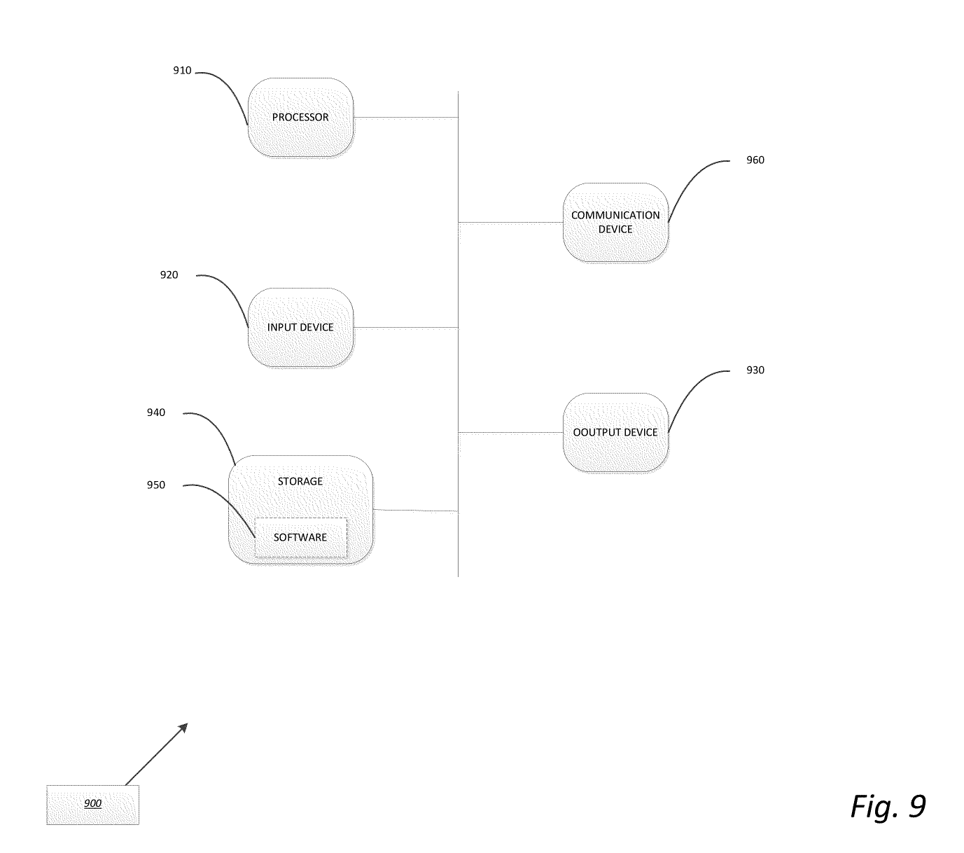

FIG. 9 illustrates the components of a basic computing device in accordance with an embodiment of the present invention; a computing device as depicted may constitute any one or more of the terminals (e.g., 801A, 801B, 801C or 804) and a server (803) running the delivery or shipment methods according to the invention, for example. The computing device may be a personal computer, workstation, server, or any other type of microprocessor-based device, including for example a mobile electronic device such as a PDA (personal digital assistant) or a smart mobile telephone. The computing device may include one or more of a processor (910), input device (920), output device (930), storage (940), and communication device (960).

The input device (920) may include a keyboard, mouse, pen-operated touch screen or monitor, voice-recognition device, or any other device that provides input. The output device (930) may include a monitor, printer, disk drive, speakers, or any other device that provides output.

The storage (940) may include volatile and nonvolatile data storage, including one or more electrical, magnetic or optical memories including such as a RAM, cache, hard drive, CD-ROM drive, tape drive or removable storage disk. The communication device (960) may include a modem, network interface card, or any other device capable of transmitting and receiving signals over a network. The components of the computing device may be connected in any manner, such as via electrical bus or wirelessly.

The software (950), which may be stored in the storage (940) and executed by the processor (910), may include, for example, the application programming that embodies the functionality of the present invention. The software (950) may include a combination of client applications and enterprise servers such as an application server and a database server.

Communications may occur over any type of network (802), which may implement any communications protocol, which may be secured by any security protocol. Network links may include telephone lines, DSL, cable networks, T1 or T3 lines, wireless network connections, or any other arrangement that implements the transmission and reception of network signals.

The computing device may implement any operating system, such as Windows, OS, open source, Linux or UNIX. The software (950) may be written in any programming language, such as C, C++, Java, Ruby on Rails, php, .net, python, Visual Basic and/or SQL. In various embodiments, application software embodying the functionality of the present invention may be deployed on a standalone machine, in a client/server arrangement or through a Web browser as a Web-based application or Web service, for example.

With respect to the appended claims, unless stated otherwise, the term “first” does not, by itself, require that there also be a “second”.

While the particular methods, devices and systems described herein and described in detail are fully capable of attaining the above-described objects and advantages of the invention, it is to be understood that these are the presently preferred embodiments of the invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “one or more” and not “one and only one”, unless otherwise so recited in the claim.

It will be appreciated that modifications and variations of the invention are covered by the above teachings and within the purview of the appended claims without departing from the spirit and intended scope of the invention. For example, software modules that implement the present invention such as the delivery or shipment server 803 may comprise several discrete modules that together still provide the same functionality, data may be spread over several databases and/or systems (e.g., a server may be two or more servers acting together or may be dispersed in the internet cloud). As used herein and in the appended claims, a “server” should be understood to refer to one server or more than one server.

What is claimed is:

1. A method for delivering a package from a shipper to a consignee comprising:
(a) obscuring the consignee's identification during a first portion of said delivery between said shipper and said consignee; and
(b) obscuring the shipper's identification during a second portion of said delivery between said shipper and said consignee.

2. The method of claim 1, wherein said shipper identification includes shipper name and address and consignee identification includes consignee name and address.

3. The method of claim 1, wherein said first portion of said delivery starts after said package leaves said shipper and ends at a first midpoint between said shipper and said consignee.

4. The method of claim 1, wherein said second portion of said delivery starts at a second midpoint between said shipper and said consignee and ends before said package is delivered to said consignee.

5. The method of claim 4, wherein said second midpoint is after said first midpoint.

6. The method of claim 4, wherein said first midpoint and said second midpoint are the same.

7. The method of claim 1, wherein said shipper's identification and said consignee's identification are both obscured during said first portion and said second portion.

8. The method of claim 1, wherein said consignee's identification is disguised during said first portion.

9. The method of claim 1, wherein said shipper's identification is disguised during said second portion.

10. The method of claim 1, further comprising generating a first waybill for package application for said first portion that obscures said consignee's identification.

11. The method of claim 1, further comprising generating a second waybill for said second portion that obscures said shipper's identification.

12. The method of claim 1, further comprising generating a first waybill for said first portion that disguises said consignee's identification.

13. The method of claim 1, further comprising generating a second waybill for said second portion that disguises said shipper's identification.

14. The method of claim 1, further comprising generating a first waybill for said first portion that omits said consignee's identification.

15. The method of claim 1, further comprising generating a second waybill for said second portion that omits said shipper's identification.

16. The method of claim 1, further comprising generating a waybill that obscures said shipper's identification and said consignee's identification.

17. The method of claim 1, further comprising generating a waybill that disguises said shipper's identification and said consignee's identification.

18. The method of claim 1, further comprising generating a waybill that omits said shipper's identification and said consignee's identification.

19. The method of claim 1, further comprising receiving a request from said shipper to cloak said shipper identification and/or said consignee identification.

20. The method of claim 1, further comprising receiving a request from said shipper to obscure said shipper identification and/or said consignee identification.

21. The method of claim 1, further comprising receiving a request from said shipper to omit said shipper identification and/or said consignee identification.

22. The method of claim 1, further comprising receiving a request from said shipper to disguise said shipper identification and/or said consignee identification.

23. The method of claim 1, further comprising generating fictitious shipper and consignee routing information to disguise the shipper and consignee information

24. The method of claim 1, further comprising creating shipping documents that disguise the shipper and the consignee.

25. The method of claim 1, further comprising creating shipping documents that omit the shipper identification and the consignee identification.

26. The method of claim 1, further comprising creating shipping documents that includes fictitious routing information.

27. The method of claim 1, further comprising replacing consignee disguised routing information with shipper disguised routing information.

28. The method of claim 1, further comprising allowing said shipper to track said package during delivery.

29. The method of claim 1, further comprising allowing said consignee to track said package during delivery.

30. The method of claim 1, further comprising notifying said consignee of said shipment.

31. The method of claim 1, further comprising notifying said consignee of said shipment and it's cloaked status.

32. The method of claim 1, further comprising assigning a cloaked shipment identification to the package in addition to a carrier assigned shipment identification.

33. The method of claim 1, comprising automatically creating fictitious shipper and consignee routing information.

34. The method of claim 33, further comprising storing fictitious shipper/consignee routing information.

35. The method of claim 33, further comprising selecting existing fictitious shipper and consignee routing information from one or more computer-based databases.

36. The method of claim 35, further comprising assigning cloaked consignee identification to the package and the actual shipper information for outbound transit from the shipper.

37. The method of claim 1, further comprising using cloaked shipper information and the actual consignee information for inbound transit to the consignee.

38. The method of claim 1, further comprising using fictitious shipper information, a shipment identification, a carrier assigned identification and the actual consignee information for inbound transit to the consignee.

39. The method of claim 1 comprising producing limited shipping status information about the in-transit package when tracked via an in-transit shipment id.

40. The method of claim 36, further comprising using a unique shipper waybill identifier.

41. The method of claim 37 further comprising using a unique consignee waybill number.

42. The method of claim 1 further comprising allowing said shipper and said consignee to share all cloaked package shipment information via a user identifier and password.

43. A method for delivering a package from a shipper to a consignee using a computer-based system, comprising:
receiving by a server a request from said shipper to deliver said package using cloaked shipment to said consignee;
determining whether one or more rules associated with cloaked shipment apply to the request from said shipper;
processing the request if all rules determined to be applicable are satisfied; and
denying the request if one or more rules determined to be applicable are not satisfied;
wherein method delivers said package from said shipper to said consignee and further comprises:
(i) obscuring the consignee's identification during a first portion of said delivery between said shipper and said consignee; and
(ii) obscuring the shipper's identification during a second portion of said delivery between said shipper and said consignee.

44. A computer based system capable of facilitating the delivery of packages from one or more shippers to one or more consignees comprising a processor coupled to a memory, the memory having computer readable code, which when executed by the processor causes the computer system to perform the method of claim 1.
